(19) United States
(12) Patent Application Publication
(10) Pub. No.: US 2004/0104937 A1
(43) Pub. Date: Jun. 3, 2004

(54) Multimedia calendar system

(76) Inventor: Hyun-Gi An, Kyunggi-Do (KR)

Correspondence Address: CANTOR COLBURN, LLP, 55 GRIFFIN ROAD SOUTH, BLOOMFIELD, CT, 06002

(21) Appl. No.: 10/472,687

(22) PCT Filed: Mar. 25, 2002
(86) PCT No.: PCT/KR02/00512

(30) Foreign Application Priority Data
Mar. 26, 2001 (KR) 2001-15800
Mar. 18, 2002 (KR) 2002-14567

(51) Int. Cl. G09G 5/00

(52) U.S. Cl. 345/764

(57) ABSTRACT

A video calendar system for providing a video calendar as a background image of an operating system (OS) with a graphical user interface (GUI) environment and applying a variety of variations to the video calendar according to a user's settings to provide novel pleasant images to the user. The video calendar system comprises an environment setup unit for setting up a video calendar output environment, a storage unit for storing moving image data, calendar constituent data, and environment configuration information set up by the environment setup unit, a video calendar creator for selecting moving image data and calendar constituent data from the storage unit on the basis of the environment configuration information set up by the environment setup unit and synthesizing the selected moving image data and calendar constituent data to create a video calendar to be reproduced on a background screen, and a display unit for displaying the video calendar created by the video calendar creator on the background screen, and a controller for controlling the entire system operation.

### TECHNICAL FIELD

The present invention relates to a video calendar system, and more particularly to a technique for providing a moving image as a background image of an operating system (OS) with a graphical user interface (GUI) environment, such as Windows 95, Windows 98 or Windows XP.

### BACKGROUND ART

Conventional techniques for providing a moving image as a background image of an OS with a GUI environment are shown in Korean Patent Application No. 2001-5679 (Feb. 6, 2001) and Korean Patent Application No. 2001-5680 (Feb. 6, 2001).

However, the above conventional techniques are related to only a video reproduction technique for reproducing a moving image on a background screen, and have presented only directions of various application techniques utilizing the video reproduction technique, without referring to details thereof.

In this regard, this inventor has made a study of a video calendar system which is capable of providing a video calendar on a background screen on the basis of the above-mentioned background screen video reproduction technique to provide convenience to a user, additionally providing a diary function in the video calendar so that the user can easily manage his/her schedule without using a separate calendar or diary program, and changing a moving image according to the user's settings to provide a variety of pleasant visual images to the user.

### DISCLOSURE OF THE INVENTION

Therefore, the present invention has been made in view of the above problems, and it is an object of the present invention to provide a video calendar system which is capable of synthesizing a calendar with a moving image to be reproduced on a background screen of an operating system (OS) with a graphical user interface (GUI) environment to create a video calendar, and applying a variety of variations to the created video calendar according to a user's settings.

It is another object of the present invention to provide a video calendar system which is capable of providing a diary function in a video calendar to be reproduced on a background screen.

It is yet another object of the present invention to provide a video calendar system which is capable of updating a video calendar to be reproduced on a background screen over the Internet.

In accordance with one aspect of the present invention, the above and other objects can be accomplished by the provision of a video calendar system executable in a client computer, comprising: environment setup means for setting up a video calendar output environment; storage means for storing at least one moving image data, at least one calendar constituent data, and environment configuration information set up by the environment setup means; video calendar creation means for selecting moving image data and calendar constituent data from the storage means on the basis of the environment configuration information set up by the environment setup means and synthesizing the selected moving image data and calendar constituent data to create a video calendar to be reproduced on a background screen; display means for displaying the video calendar created by the video calendar creation means on the background screen; and control means for controlling the entire system operation.

Preferably, the video calendar system may further comprise diary processing means for receiving from a client characters corresponding respectively to dates indicated in the video calendar created by the video calendar creation means, storing the received characters in the storage means and selectively outputting the stored characters according to selection information from the client.

The video calendar system may further comprise: communication means connected to a network for transmitting and receiving data to/from the network; and data updating means for receiving moving image data and calendar constituent data from a specific server through the communication means and storing them in the storage means.

In accordance with another aspect of the present invention, there is provided a video calendar system executable in a server computer, comprising: storage means for storing at least one moving image data and at least one calendar constituent data; communication means networked to a client computer for transmitting and receiving data to/from the client computer; data processing means for selecting moving image data and calendar constituent data from the storage means in response to input information from the client computer networked to the communication means and sending the selected moving image data and calendar constituent data to the client computer through the communication means; and control means for controlling the entire system operation.

Preferably, the video calendar system may further comprise reservation processing means for receiving reservation information from the client computer and automatically sending the moving image data and calendar constituent data and/or environment configuration information to the client computer on the basis of the received reservation information at a reserved time included therein.

The video calendar system may further comprise authentication processing means for processing a user authentication on the basis of access information from the client computer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of a video calendar system in accordance with a first embodiment of the present invention;

FIG. 2 is a block diagram showing the construction of a video calendar system in accordance with a second embodiment of the present invention; and

FIG. 3 is a block diagram showing the construction of a video calendar system in accordance with a third embodiment of the present invention.

### BEST MODE FOR CARRYING OUT THE INVENTION

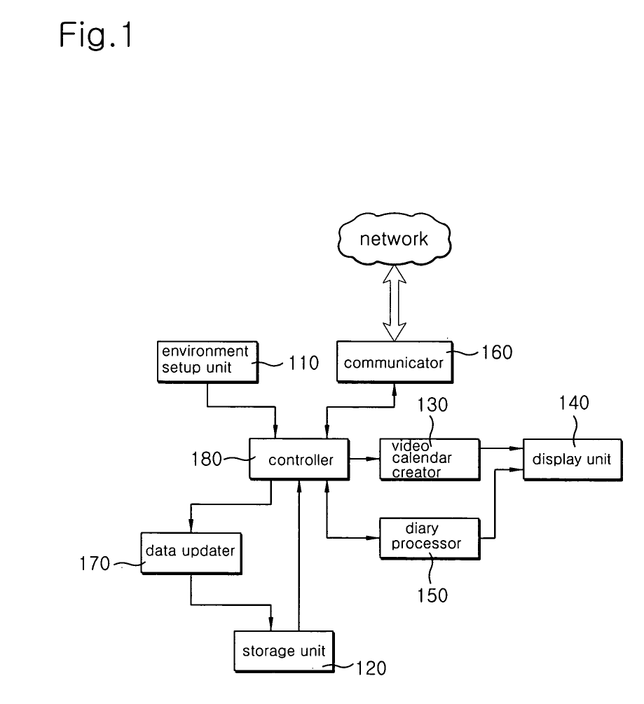

FIG. 1 is a block diagram showing the construction of a video calendar system in accordance with a first embodiment of the present invention, which is a client module.

In the present embodiment, the video calendar system is executable in a client computer.

As shown in FIG. 1, the video calendar system according to the first embodiment comprises an environment setup unit 110, a storage unit 120, a video calendar creator 130, a display unit 140, a diary processor 150, a communicator 160, a data updater 170 and a controller 180.

The environment setup unit 110 is adapted to set up a video calendar output environment. That is, the environment setup unit 110 receives a client or user's settings regarding moving image data to be reproduced on a background screen of an operating system (OS) with a graphical user interface (GUI) environment and calendar constituent data to be synthesized and reproduced with the moving image data, and updates environment configuration information with the received settings. Provided that there are no settings from the user regarding moving image data to be reproduced on the background screen and calendar constituent data to be synthesized and reproduced with the moving image data, the moving image data and the calendar constituent data are automatically selected according to defaults.

Preferably, the environment setup unit 110 sets up the environment configuration information in such a manner that different moving image data can be outputted to the background screen at different times. As a result, moving images with variations can be reproduced on days/months/weeks/special occasions according to the user's environment settings, so as to provide a variety of pleasant visual images to the user. In this case, the environment configuration information has to include a reproduction list with moving image reproduction dates and times.

The storage unit 120 is adapted to store at least one moving image data, at least one calendar constituent data, and the environment configuration information set up by the environment setup unit 110. Namely, the storage unit 120 stores data about a variety of moving image contents and calendar constituent elements constituting a video calendar to be reproduced, and environment configuration information for setup of a reproduction environment of the video calendar.

The video calendar creator 130 is adapted to select moving image data and calendar constituent data from the storage unit 120 on the basis of the environment configuration information from the environment setup unit 110 and synthesize the selected moving image data and calendar constituent data to create a video calendar to be reproduced on the background screen. In order to create a video calendar, calendar constituent elements must be synthesized with a moving image to be reproduced on the background screen. In this regard, the video calendar creator 130 creates a video calendar to be reproduced on the background screen by loading moving image data and calendar constituent data to be reproduced from the storage unit 120 according to the environment configuration information and synthesizing the loaded moving image data and calendar constituent data. Preferably, the environment configuration information includes synthesis information for the synthesis of the loaded moving image data and calendar constituent data. The synthesis information may be, for example, information regarding a synthesis technique including AND, OR, NOR and XOR operations, or a screen separation technique for displaying a moving image and a calendar respectively on separated screens.

The display unit 140 is adapted to display the video calendar created by the video calendar creator 130 on the background screen. That is, the display unit 140 reproduces the video calendar created by the video calendar creator 130 on the background screen, which is provided by an operating system (OS) with a graphical user interface (GUI) environment. Techniques for reproducing a moving image on the background screen are disclosed in Korean Patent Application No. 2001-5679 (Feb. 6, 2001) and Korean Patent Application No. 2001-5680 (Feb. 6, 2001), filed prior to this application, and a detailed description thereof will thus be omitted.

The diary processor 150 is adapted to receive from the client characters corresponding respectively to dates indicated in the video calendar created by the video calendar creator 130, store the received characters in the storage unit 120 and selectively output the stored characters according to selection information from the client. Namely, the diary processor 150 enables the user to take and confirm a memo of desired information on the background screen at any time.

In the present embodiment, a video calendar to be reproduced on the background screen includes moving image data and calendar constituent data, which is a numerically expressed text or text image selectable by the user. If such a text or text image is selected by the user, a character output window is displayed, and the user can enter a desired character in the displayed character output window, store the entered character, and select and view the stored character if necessary. This function is processed by the diary processor 150.

The communicator 160 is connected to a network to transmit and receive data. Namely, the client computer transmits and receives data to/from an external network through the communicator 160.

The data updater 170 is adapted to receive moving image data and calendar constituent data from a specific server through the communicator 160 and store them in the storage unit 120. That is, the data updater 170 gains access to a video calendar service provision server, and downloads and stores moving image data and calendar constituent data therefrom so that the user can selectively use the stored moving image data and calendar constituent data. As a result, the data updater 170 enables the client to use a variety of moving image data and calendar constituent data supported by the specific server.

Preferably, the data updater 170 further functions to receive environment configuration information for setup of a video calendar output environment from the specific server through the communicator 160 and store it in the storage unit 120. In other words, the specific server provides environment configuration information including information regarding moving image data and calendar constituent data to be reproduced on the background screen and various setting information, and the client downloads and stores the environment configuration information provided from the specific server through the communicator 160. The data updater 170 can download moving image data and calendar constituent data corresponding to the stored environment configuration information from the specific server and update a background image with the downloaded moving image data and calendar constituent data.

Preferably, the data updater 170 also acts to automatically receive moving image data and calendar constituent data or environment configuration information from the specific server at a reserved time included in settings for reservation, and store the received moving image data and calendar constituent data or environment configuration information in the storage unit 120. That is, provided that the client sets a reserved date and time for updating of data in advance, the client computer is automatically connected to the specific server by the operation of the data updater 170 at the set date and time to receive moving image data and calendar constituent data or environment configuration information from the specific server, and update existing data or information with the received moving image data and calendar constituent data or environment configuration information.

The controller 180 is adapted to control the entire client-oriented system operation. Namely, the controller 180 controls the entire client-oriented video calendar system operation including an operation of outputting and reproducing selected moving image data and calendar constituent data on the background screen of the OS with the GUI environment according to an environment set up by the environment configuration information.

The operation of the video calendar system executable in the client module is performed under the control of the controller 180 in the following manner. The environment setup unit 110 sets up a video calendar output environment, and the video calendar creator 130 loads moving image data and calendar constituent data from the storage unit 120 according to environment configuration information set up by the environment setup unit 110 and synthesizes the loaded moving image data and calendar constituent data to create a video calendar to be reproduced on the background screen. The display unit 140 reproduces the video calendar created by the video calendar creator 130 on the background screen, which is provided by the OS with the GUI environment.

On the other hand, the user can take and confirm a memo of desired information on the background screen at any time through the diary processor 150. Also, the user can download and store moving image data and calendar constituent data and/or environment configuration information from the specific server through the data updater 170 so as to selectively use the stored moving image data and calendar constituent data and/or environment configuration information. Accordingly, the client is able to use a variety of moving image data and calendar constituent data supported by the specific server.

Preferably, the environment configuration information includes information regarding moving image data to be reproduced and calendar constituent data to be synthesized and reproduced with the moving image data. The environment configuration information further includes a reproduction list with reproduction dates and times of moving images to be reproduced according to days/months/weeks/special occasions. The environment configuration information further includes information about a moving image data/calendar constituent data synthesis technique or a moving image data/calendar constituent data screen separation technique. As a result, variations can be applied to the background screen to provide a variety of pleasant visual images to the user.

On the other hand, the data updater 170 performs its updating operation in such a manner as to automatically receive moving image data and calendar constituent data or environment configuration information from the specific server at a reserved time included in settings for reservation. Accordingly, the data or information updating can be readily conducted.

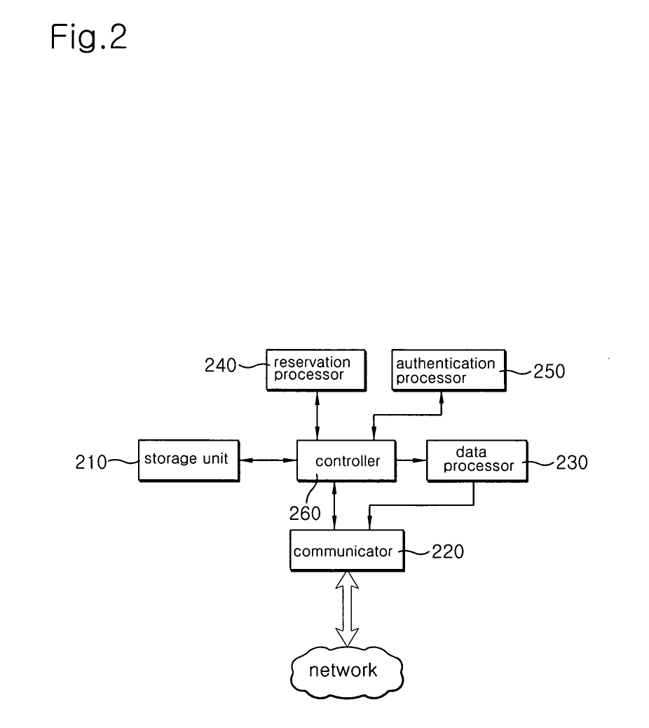

FIG. 2 is a block diagram showing the construction of a video calendar system in accordance with a second embodiment of the present invention, which is a server module.

In the present embodiment, the video calendar system is executable in a server computer.

As shown in FIG. 2, the video calendar system according to the second embodiment comprises a storage unit 210, a communicator 220, a data processor 230, a reservation processor 240, an authentication processor 250 and a controller 260.

The storage unit 210 is adapted to store at least one moving image data and at least one calendar constituent data. Namely, the storage unit 210 stores data about a variety of moving image contents and calendar constituent elements constituting a video calendar to be reproduced, and environment configuration information for setup of a reproduction environment of the video calendar, and provides the stored data and information to a client.

The communicator 220 is connected to a client computer over a network to transmit and receive data to/from the client computer. That is, the server computer exchanges data with a number of client computers connected to the communicator 220.

The data processor 230 is adapted to select moving image data and calendar constituent data from the storage unit 210 in response to input information from a client computer connected to the communicator 220 and send the selected moving image data and calendar constituent data to the client computer through the communicator 220.

Preferably, the data processor 230 is further adapted to select environment configuration information from the storage unit 210 in response to input information from a client computer connected to the communicator 220 and send the selected environment configuration information to the client computer through the communicator 220. In this case, the storage unit 210 has to store at least one environment configuration information for setup of a video calendar output environment in the client computer.

Therefore, the server loads corresponding moving image data and calendar constituent data and/or environment configuration information from the storage unit 210 through the data processor 230 in response to selection information inputted from a client computer connected thereto and sends the loaded moving image data and calendar constituent data and/or environment configuration information to the client computer through the communicator 220.

The reservation processor 240 is adapted to receive reservation information from a client computer and automatically send moving image data and calendar constituent data and/or environment configuration information to the client computer on the basis of the received reservation information at a reserved time included therein.

In other words, provided that the video calendar system executed in each client computer has reservation information set for updating from the server over the Internet, each client computer is connected to the server at a reserved date and time included in the reservation information to send the reservation information to the server. Upon receiving the reservation information from each client computer, the server automatically sends moving image data and calendar constituent data and/or environment configuration information to each client computer on the basis of the received reservation information through the reservation processor 240 to update existing data and/or information.

The authentication processor 250 is adapted to process a user authentication on the basis of access information from a client computer. That is, the authentication processor 250 determines whether a user of the client computer is a person authorized to use the server, and permits the user to use various data associated with a video calendar, provided from the server, using the client computer if he/she is authenticated as an authorized person.

The controller 260 is adapted to control the entire server-oriented system operation. Namely, the controller 260 controls the entire server-oriented video calendar system operation including an operation of sending moving image data and calendar constituent data and/or environment configuration information to a client computer networked to the server in response to input information from the client computer.

The operation of the video calendar system executable in the server module is performed under the control of the controller 260 in the following manner. In response to a request from a client computer connected to the communicator 220, the data processor 230 loads moving image data and calendar constituent data and/or environment configuration information from the storage unit 210 and sends the loaded data and/or information to the client computer.

The reservation processor 240 automatically sends moving image data and calendar constituent data and/or environment configuration information to a client computer at a reserved date and time included in reservation information from the client computer to update existing data and/or information. The authentication processor 250 permits only an authenticated client computer to use various data associated with a video calendar, provided from the server.

Therefore, according to the present embodiment, the server can provide various types of moving image data and calendar constituent data to clients.

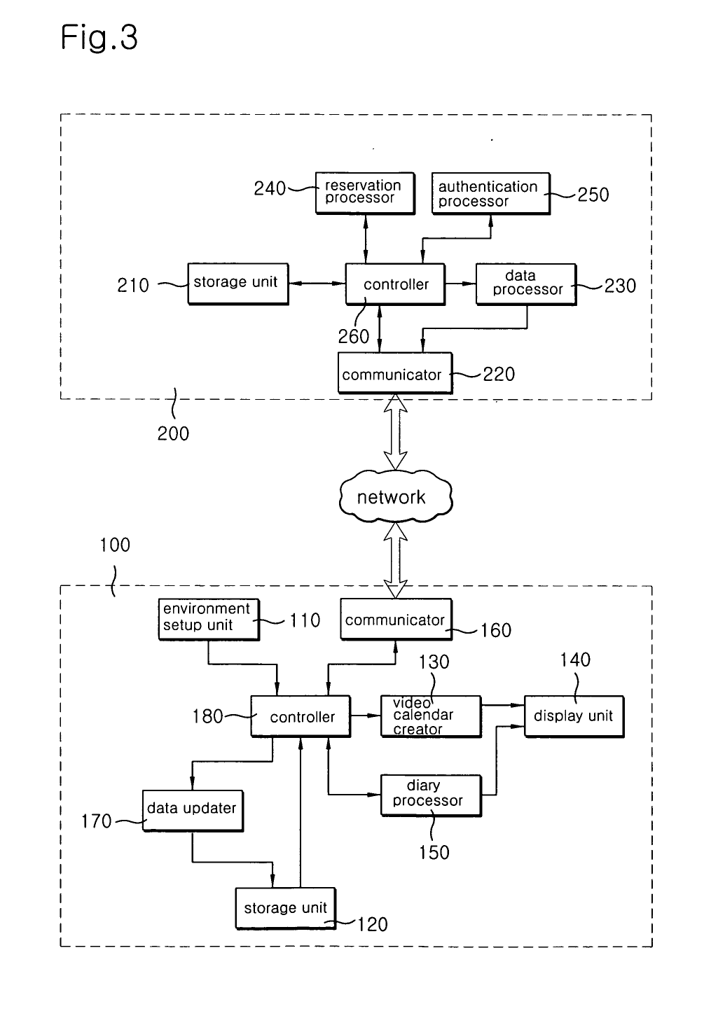

FIG. 3 is a block diagram showing the construction of a video calendar system in accordance with a third embodiment of the present invention, which is the combination of a client module and a server module.

In the present embodiment, the video calendar system comprises a server module 200 and a client module 100.

The server module 200 includes a storage unit 210 for storing at least one moving image data and at least one calendar constituent data, a communicator 220 networked to a client computer for transmitting and receiving data to/from the client computer, a data processor 230 for selecting moving image data and calendar constituent data from the storage unit 210 in response to input information from the client computer networked to the communicator 220 and sending the selected moving image data and calendar constituent data to the client computer through the communicator 220, and a controller 260 for controlling the entire server-oriented system operation. The server module 200 further includes an authentication processor 250 for processing a user authentication on the basis of access information from the client computer, and a reservation processor 240 for receiving reservation information from the client computer and automatically sending moving image data and calendar constituent data and/or environment configuration information to the client computer on the basis of the received reservation information at a reserved time included therein.

The client module 100 includes a communicator 160 networked to the server for transmitting and receiving data to/from the server, an environment setup unit 110 for setting up a video calendar output environment, a video calendar creator 130 for synthesizing moving image data and calendar constituent data received from the server on the basis of environment configuration information set up by the environment setup unit 110 to create a video calendar to be reproduced on a background screen, a display unit 140 for displaying the video calendar created by the video calendar creator 130 on the background screen, and a controller 180 for controlling the entire client-oriented system operation. The client module 100 further includes a storage unit 120 for storing the moving image data and calendar constituent data received from the server and the environment configuration information set up by the environment setup unit 110, a diary processor 150 for receiving from the client characters corresponding respectively to dates indicated in the video calendar created by the video calendar creator 130, storing the received characters in the storage unit 120 of the client module 100 and selectively outputting the stored characters according to selection information from the client, and a data updater 170 for receiving the moving image data and calendar constituent data from the server through the communicator 160 and storing them in the storage unit 120.

Preferably, the environment setup unit 110 may set up the environment configuration information in such a manner that different moving image data can be outputted to the background screen at different times.

The respective parts of the server module and client module in the third embodiment shown in FIG. 3 are the same in construction and operation as those in the first and second embodiments shown in FIGS. 1 and 2, and a detailed description thereof will thus be omitted.

According to the present invention, the video calendar system is executable in only the client module, or in an online combination of the client module and server module as in the third embodiment.

Therefore, the objects of the present embodiment can be accomplished by providing the video calendar system as in the first to third embodiments.

### Industrial Applicability

As apparent from the above description, the present invention provides a video calendar system which is capable of synthesizing a calendar with a moving image to be reproduced on a background screen of an operating system (OS) with a graphical user interface (GUI) environment to create a video calendar, and applying a variety of variations to the created video calendar according to a user's settings to provide novel pleasant images to the user. Further, a diary function is provided in the video calendar to be reproduced on the background screen, thereby enabling the user to take and confirm a memo of desired information on the background screen at any time, Moreover, the video calendar to be reproduced on the background screen can be updated over the Internet, thereby enabling the user to create a background image according to his/her tastes.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A video calendar system executable in a client computer, comprising:
environment setup means for setting up a video calendar output environment;
storage means for storing at least one moving image data, at least one calendar constituent data, and environment configuration information set up by said environment setup means;
video calendar creation means for selecting moving image data and calendar constituent data from said storage means on the basis of said environment configuration information set up by said environment setup means and synthesizing the selected moving image data and calendar constituent data to create a video calendar to be reproduced on a background screen;
display means for displaying said video calendar created by said video calendar creation means on said background screen; and
control means for controlling the entire system operation.

2. The video calendar system as set forth in claim 1, further comprising diary processing means for receiving from a client characters corresponding respectively to dates indicated in said video calendar created by said video calendar creation means, storing the received characters in said storage means and selectively outputting the stored characters according to selection information from said client.

3. The video calendar system as set forth in claim 1 or claim 2, further comprising:
communication means connected to a network for transmitting and receiving data to/from said network; and
data updating means for receiving moving image data and calendar constituent data from a specific server through said communication means and storing them in said storage means.

4. The video calendar system as set forth in claim 3, wherein said data updating means is further adapted to receive environment configuration information for setup of said video calendar output environment from said specific server through said communication means and store it in said storage means.

5. The video calendar system as set forth in claim 3, wherein said data updating means is further adapted to automatically receive said moving image data and calendar constituent data from said specific server at a reserved time included in settings for reservation and store the received moving image data and calendar constituent data in said storage means.

6. The video calendar system as set forth in claim 4, wherein said data updating means is further adapted to automatically receive said environment configuration information from said specific server at a reserved time included in settings for reservation and store the received environment configuration information in said storage means.

7. The video calendar system as set forth in any one of claim 1, claim 2, claim 4, claim 5 and claim 6, wherein said environment setup means is further adapted to set up said environment configuration information in such a manner that different moving image data can be outputted to said background screen at different times.

8. The video calendar system as set forth in claim 3, wherein said environment setup means is further adapted to set up said environment configuration information in such a manner that different moving image data can be outputted to said background screen at different times.

9. A video calendar system executable in a server computer, comprising:
storage means for storing at least one moving image data and at least one calendar constituent data;
communication means networked to a client computer for transmitting and receiving data to/from said client computer;
data processing means for selecting moving image data and calendar constituent data from said storage means in response to input information from said client computer networked to said communication means and sending the selected moving image data and calendar constituent data to said client computer through said communication means; and
control means for controlling the entire system operation.

10. The video calendar system as set forth in claim 9, wherein said storage means is further adapted to store at least one environment configuration information for setup of a video calendar output environment in said client computer; and
wherein said data processing means is further adapted to select environment configuration information from said storage means in response to said input information from said client computer networked to said communication means and send the selected environment configuration information to said client computer through said communication means.

11. The video calendar system as set forth in claim 9 or claim 10, further comprising reservation processing means for receiving reservation information from said client computer and automatically sending said moving image data and calendar constituent data and/or environment configuration information to said client computer on the basis of the received reservation information at a reserved time included therein.

12. The video calendar system as set forth in claim 9 or claim 10, further comprising authentication processing means for processing a user authentication on the basis of access information from said client computer.

13. The video calendar system as set forth in claim 11, further comprising authentication processing means for processing a user authentication on the basis of access information from said client computer.

14. A video calendar system comprising:
a server module including:
first storage means for storing at least one moving image data and at least one calendar constituent data;
first communication means networked to a client computer for transmitting and receiving data to/from said client computer;
data processing means for selecting moving image data and calendar constituent data from said first storage means in response to input information from said client computer networked to said first communication means and sending the selected moving image data and calendar constituent data to said client computer through said first communication means; and
first control means for controlling the entire server-oriented system operation; and
a client module including:
second communication means networked to said server for transmitting and receiving data to/from said server;
environment setup means for setting up a video calendar output environment;
video calendar creation means for synthesizing moving image data and calendar constituent data received from said server on the basis of environment configuration information set up by said environment setup means to create a video calendar to be reproduced on a background screen;
display means for displaying said video calendar created by said video calendar creation means on said background screen; and
second control means for controlling the entire client-oriented system operation.

15. The video calendar system as set forth in claim 14, wherein said client module further includes second storage means for storing said moving image data and calendar constituent data received from said server and said environment configuration information set up by said environment setup means.

16. The video calendar system as set forth in claim 14 or claim 15, wherein said client module further includes diary processing means for receiving from said client characters corresponding respectively to dates indicated in said video calendar created by said video calendar creation means, storing the received characters in said second storage means and selectively outputting the stored characters according to selection information from said client.

17. The video calendar system as set forth in claim 16, wherein said client module further includes data updating means for receiving said moving image data and calendar constituent data from said server through said second communication means and storing them in said second storage means.

18. The video calendar system as set forth in claim 17, wherein said server module further includes authentication processing means for processing a user authentication on the basis of access information from said client computer.

19. The video calendar system as set forth in claim 18, wherein said server module further includes reservation processing means for receiving reservation information from said client computer and automatically sending said moving image data and calendar constituent data and/or environment configuration information to said client computer on the basis of the received reservation information at a reserved time included therein.

20. The video calendar system as set forth in any one of claim 14, claim 15, claim 17, claim 18 and claim 19, wherein said environment setup means of said client module is further adapted to set up said environment configuration information in such a manner that different moving image data can be outputted to said background screen at different times.
